(19) United States
(12) Patent Application Publication
(10) Pub. No.: US 2019/0343156 A1
(43) Pub. Date: Nov. 14, 2019

(54) Methods and Compositions for Plant-Based Breakfast Bowls

(71) Applicant: DAILY HARVEST, INC., New York, NY (US)

(72) Inventor: Rachel Drori, New York, NY (US)

(21) Appl. No.: 16/405,213

(22) Filed: May 7, 2019

Related U.S. Application Data
(60) Provisional application No. 62/668,478, filed on May 8, 2018.

(51) Int. Cl. A23L 3/36; A23L 19/00; A23L 7/10; A23L 11/00; A23L 27/10

(52) U.S. Cl. CPC A23L 3/36; A23L 19/03; A23L 27/10; A23L 11/01; A23L 7/10

(57) ABSTRACT

Frozen plant-based breakfast bowl products and associated precursor compositions provide a healthy, nutritious, and tasty breakfast or snack. The products and compositions are made with fresh frozen ingredients, without adding refined sugar, artificial ingredients, or artificial preservatives.

### RELATED APPLICATION

This application claims the benefit of priority to U.S. Provisional Application Ser. No. 62/668,478 filed May 8, 2018, which is incorporated herein by reference in its entirety.

### BACKGROUND

Breakfast bowls, such as oatmeal, are popular food products that may have certain drawbacks. Many commercially available products may be high in sugar and thus may be perceived as unhealthy. Furthermore, some commercially available products include processed additives, such as maple flavoring or dried fruits, such as raisins, that have reduced nutritional value. Finally, commercially available breakfast products typically contain various artificial additives and preservatives.

A need exists for the ability for a consumer to conveniently and easily make breakfast bowls that include fresh, healthy ingredients without requiring extensive preparation.

### SUMMARY

In an aspect, embodiments of the invention relate to a frozen plant-based breakfast bowl precursor composition including a frozen mixture. The frozen mixture includes a base component including a grain, a seed, and/or a nut, and a base component additive including at least one fruit. The base component is at least one of whole, unrefined, and unprocessed. Each base component additive ingredient is not dried and is at least one of whole, unrefined, and unprocessed. The composition is further characterized by an absence of refined sugar, artificial ingredients, and artificial preservatives. The frozen mixture includes at least 20% by volume the base component.

One or more of the following features may be included. The base component may include a grain such as oats, wheat, quinoa, buckwheat, farro, spelt, millet, rice, and/or teff. The base component may include a seed such as chia, sesame, pumpkin, hemp, and/or cacao. The base component may include a nut such as almonds, walnuts, coconut, hazelnuts, pine nuts, cashews, pistachios, and pecans.

The base component additive may include a fruit such as strawberry, banana, avocado, blueberry, raspberry, cherry, apple, lychee, mango, pineapple, dragon fruit, mulberry, acai, and fig. The base component additive may also include an additional additive ingredient such as fruits, vegetables, roots, spices, herbs, seeds, nuts, and/or legumes, with the additional base component additive ingredient being the same or different from the base component.

At least two base component additive ingredients may be in pellet form, each pellet comprising at least two additive ingredients mixed together with at least one of the additive ingredients being in granulated form. At least one of the additive ingredients may be a carrier with the granulated additive ingredient mixed therein.

The base component additive may include a vegetable such as carrot, sweet potato, corn, pumpkin, avocado, zucchini, mushroom, and/or beet. The base component additive may include a root, such as taro root, turmeric, and/or ginger. The base component additive may include a spice such as cinnamon, nutmeg, allspice, vanilla, clove and/or cardamom. The base component additive may include an herb, such as lemon balm, spearmint, peppermint, basil, parsley, cilantro, lavender, rosemary, sweet leaf, and/or chili pepper. The base component additive may include a seed, such as cacao, sesame, pumpkin, hemp, and chia. The base component additive comprises a nut selected from the group consisting of almond, hazelnut, pecan, walnut, brazil nut, cashew, pine nut, and coconut.

The base component additive may include a legume, such as peanuts, chickpeas, lentils, peas, and/or beans. The composition may be disposed in a sealed container. The composition may include a single portion disposed in the sealed container with the sealed container having a size ranging from 4 to 24 ounces, or multiple portions disposed in the sealed container with the sealed container having a size ranging from 8 to 48 ounces. The composition may be prepared for consumption by addition of a liquid to the container.

In another aspect, embodiments of the invention relate to a method for making a plant-based breakfast bowl for consumption. The method includes providing a frozen mixture of: base component including a grain, a seed, and/or a nut, and a base component additive including a fruit. The base component is at least one of whole, unrefined, and unprocessed. Each additive ingredient is not dried and is at least one of whole, unrefined, and unprocessed. The composition is further characterized by an absence of refined sugar, artificial ingredients, and artificial preservatives. The frozen mixture includes at least 20% by volume of the base component. A liquid is added to the frozen mixture. The mixture and the liquid are stirred. The mixture and the liquid are heated or cooled to form the breakfast bowl.

One or more of the following features may be included. The mixture and liquid may be heated with a microwave. The mixture and liquid may be cooled in a refrigerator for 4-12 hours.

The base component additive may include at least one additional additive ingredient, such as fruits, vegetables, roots, spices, herbs, seeds, nuts, and/or legumes. The frozen mixture may be provided in a sealed container. The sealed container may contain a single portion of the frozen mixture, with the sealed container having a size ranging from 4 to 24 ounces. The sealed container may contain multiple portions of the frozen mixture, with the sealed container having a size ranging from 8 to 48 ounces.

In yet another aspect, embodiments of the invention relate to a method of preparing a frozen plant-based breakfast bowl precursor composition. The method includes preparing a base component by hulling or shelling a grain, seed, or nut. A base component additive including a fruit is prepared by (i) chopping the fruit and (ii) freezing the fruit. The base component and the base component additive are mixed together to form a form a frozen mixture of the base component and the base component additive by mixing together. The base component is at least one of whole, unrefined, and unprocessed. Each additive ingredient is not dried and is at least one of whole, unrefined, and unprocessed. The composition is further characterized by an absence of refined sugar, artificial ingredients, and artificial preservatives. The frozen mixture includes at least 20% by volume the base component.

One or more of the following features may be included. The base component additive may include a pellet including at least two additive ingredients. The base component additive may further include at least one additional additive ingredient, such as fruits, vegetables, roots, spices, herbs, seeds, nuts, and/or legumes, with the additional base component additive ingredient being the same or different from the base component. The base component additive may include a pellet including at least two additive ingredients mixed together with at least one of the additive ingredients being in granulated form. At least one of the additive ingredients may be a carrier with the granulated additive ingredient mixed therein.

In still another aspect, embodiments of the invention relate to a food article including a sealed container. A frozen mixture is disposed within the container. The frozen mixture includes a base component including a grain, a seed, and/or a nut, and a base component additive including a fruit. The base component is whole, unrefined, and/or unprocessed. Each additive ingredient is not dried and is at least one of whole, unrefined, and unprocessed. The composition is further characterized by an absence of refined sugar, artificial ingredients, and artificial preservatives. The frozen mixture includes at least 20% by volume the base component.

One or more of the following features may be included. The sealed container may contain a single portion or multiple portions of the frozen mixture. The base component additive may further include at least one additional additive ingredient, such as fruits, vegetables, roots, spices, herbs, seeds, nuts, and/or legumes, with the additional base component additive ingredient being the same or different from the base component. The base component additive may include a pellet including at least two additive ingredients mixed together with at least one of the additive ingredients being in granulated form. At least one of the additive ingredients may be a carrier with the granulated additive ingredient mixed therein.

### DETAILED DESCRIPTION

As used herein, the “grain” of embodiments of the invention denotes a wheat or any other cultivated cereal used as food (see en.oxfordditionaireis.com/definition/grain).

As used herein, “processed food” means any food that has been altered from its natural state in some way, other than frozen, either for safety reasons or convenience.

As used herein, “refined food” means a food that does not contain all of its original nutrients, i.e., not a whole food.

As used herein, “whole food” means a food that is natural, unprocessed, and unrefined.

As used herein, “artificial substance” means any substance created artificially to enhance food products. For example, artificial flavoring is a specific and often complex mixture of singular naturally occurring flavor compounds combined to either imitate or enhance a natural flavor.

As used herein, “artificial preservative” means chemical substances added to foods.

As used herein, “natural flavor” or “natural flavoring” means the essential oil, oleoresin, essence or extractive, protein hydrolysate, distillate, or any product of roasting, heating or enzymolysis, that contains the flavoring constituents derived from a spice, fruit or fruit juice, vegetable or vegetable juice, edible yeast, herb, bark, bud, root, leaf or similar plant material, meat, seafood, poultry, eggs, dairy products, or fermentation products thereof, whose significant function in food is flavoring rather than nutritional.

As used herein, a “concentrate” means a concentrated form of a foodstuff, in which bulk is reduced by the removal of water.

As used herein, an “herb” is a leaf, flower or stem from a plant used for flavoring or as a garnish.

As used herein, “fresh” means in the same state as picked from the plant.

As used herein, “dried” means a concentrated form of a foodstuff, in which the water content is reduced as a method of preservation.

As used herein, “added sugar” means sugars added that are not in a state found in nature.

### Composition

Embodiments of the invention include a frozen plant-based breakfast bowl precursor composition that may be mixed with a liquid to make a food with a porridge-like or creamy texture and consistency. The precursor composition may include a frozen mixture of a base component and a base component additive. Each base component ingredient is whole, unrefined, and/or unprocessed, and each additive ingredient is not dried and is whole, unrefined, and/or unprocessed. The precursor composition does not include any added sugar, artificial ingredients, and artificial preservatives. The frozen mixture includes at least 20% by volume of the base component

In particular, the base component includes a grain, a seed, and/or a nut. The grain may be, e.g., oats, wheat, quinoa, buckwheat, farro, spelt, millet, rice, and/or teff. The seed may be, e.g., chia, sesame, pumpkin, hemp, and/or cacao. The nut may be, e.g., almonds, walnuts, coconut, hazelnuts, pine nuts, cashews, pistachios, and/or pecans.

The base component additive includes at least one fruit, primarily to enhance the flavor of the product, and also to provide nutritional value. In some embodiments, base component may also additionally include vegetables, roots, spices, herbs, seeds, nuts, and/or legumes. The ingredients of the base component additive are selected to add flavor and/or nutritional value to the base. In addition to loose ingredients, the base component additive may include two or more ingredients formed into a pellet. Forming pellets helps ensure that the ingredients in the pellets do not stick to the sidewall of a container in which the grain-based composition may be provided to the consumer. The use of pellets also helps ensure proper and uniform dosage in each container. The pellet is preferably sized such that, during preparation for consumption, the pellets are small enough to properly blend with the base component and dissolve into the finished product during the absorption or the heating steps, as discussed below. Preferably, the pellet has a diameter of about 0.25″ to 0.5″ and a length of about 0.5″ to 1″.

The base component additive includes a fruit, e.g., strawberry, banana, avocado, blueberry, raspberry, cherry, apple, lychee, mango, pineapple, dragon fruit, mulberry, acai, and/or fig. In addition, the base component additive may include a vegetable such as carrot, sweet potato, corn, pumpkin, avocado, zucchini, mushroom, and/or beet. In addition or alternatively, the base component additive may include a root such as taro root, turmeric, and/or ginger. The base component additive may include a spice such as cinnamon, nutmeg, allspice, vanilla, clove, and/or cardamom. In addition or alternatively, the base component additive may include an herb such as lemon balm, spearmint, peppermint, basil, parsley, cilantro, lavender, rosemary, sweet leaf, and/or chili pepper. The base component additive may include a seed, such as cacao, sesame, pumpkin, hemp, and/or chia. The base component additive may include a nut such as almond, hazelnut, pecan, walnut, Brazil nut, cashew, pine nut and/or coconut. The base component additive may be a legume, such as peanut, chickpeas, lentils, peas, and/or beans.

The frozen breakfast bowl precursor composition, i.e., a frozen mixture of the base component and base component additive, may be a single portion disposed in a sealed, single-service container. Alternatively, multiple portions of the frozen mixture may be disposed in a sealed container. For example, the frozen mixture of the base component and base component additive together may weigh 4 ounces and may be packaged in a 4 ounce cardboard cup with a lid; alternatively, the frozen precursor composition may weigh, e.g., 8 ounces, 12 ounces, 16 ounces, 20 ounces, 24 ounces, or any other suitable weight, and may be packaged in an 8 ounce, 12 ounce, 16 ounce, 24 ounce, or other suitably sized container, respectively. Typically, the container will have a volume of e.g., 2×, 3×, 4×, 5×, or greater than the volume of the base component and additive combined, so as to receive any liquid to be added thereto for preparation of the breakfast bowl.

The frozen mixture preferably includes at least 20 vol % base component, with the remainder being the base component additive. The base component delivers nutritional value and determines the consistency of the end-product in terms of, e.g., texture and taste. Accordingly, a minimum of about 20 vol % of the base component is preferred. In some embodiments, it is preferred that the product include no more than 75 vol % base component, as a higher percentage of the base component may be detrimental to the product consistency.

The frozen plant-based breakfast bowl precursor composition is prepared for consumption by addition of a liquid to the frozen mixture and allowing the frozen mixture to absorb the liquid and to thaw, as described below.

### Method of Preparation of Frozen Breakfast Bowl Precursor Composition

The base component for the breakfast bowl precursor may be prepared as follows. The desired ingredients, i.e., a grain, seed, and/or nuts, are hulled or shelled. In some embodiments, the base component ingredients may be quick frozen by an IQF system, e.g., a CRYOGRAN system from IQF Inc., based in Ontario, Canada. In an embodiment, the nut may be a coconut that is milled to form flour.

The base component additive ingredient(s) are selected based on taste and nutrition content. The additive includes fruit and may include one or more of a vegetable, a root, spice, herb, seed, nut, or legume. The additive ingredients may be cut into chunks and frozen. A shredder or a chopper may be used. For example, bananas may be cut into slices using a FAM Mantis.2®, and sweet potato may be cut into chunks using FAM TRIDIS™ 240, manufactured by FAM NV, based in Antwerp, Belgium. Preferably, the chunks are sufficiently small to facilitate packaging, e.g., the chunks may have a largest dimension of about 4″, preferably 2″, and more preferably 1″. Preferably, the chunks are uniform in size. After the cutting and/or chopping step, the chunks of base component additive ingredients are frozen to form the base component additive. The chunks may be individually quick frozen by use of an IQF system, e.g., a CRYOGRAN system from IQF Inc., based in Ontario, Canada. Alternatively, the chunks may be frozen in molds or on trays in a suitable freezer.

Alternatively, at least a portion of the additive ingredients may be combined into a pellet form. Forming pellets may be especially preferable for ingredients that may stick to each other or to a side of a container when packaged, thereby making it difficult to distribute such ingredients uniformly. Ingredients that tend to stick include powders, such as a spice or cacao, and butters, such as nut butter.

Pellets may be formed by IQF as follows. First, a uniform mixture of additive ingredients is created by mixing the desired ingredients until a uniform mixture or suspension is formed. At least one additive ingredient may be sufficiently viscous to act as a carrier to allow a mixture/suspension to form, without being so viscous that the mixture/suspension cannot flow freely. Suitable additive ingredients for a carrier may be, e.g., an oil (e.g., coconut oil), a butter (e.g., a nut butter or coconut butter), a puree (e.g., sweet potato puree or apple puree), etc. Some additive ingredients may be pre-emptively granulated by, e.g., chopping, shredding, mashing, slicing, and/or grating. The granulated additive ingredients may be, e.g., fruits, vegetables, roots, spices, herbs, seeds, nuts, and/or legumes. The uniform mixture may be fed through an IQF pelletizer, e.g., a CRYOGRAN system. The IQF pelletizer outputs frozen shapes of the desired ingredients for base component additive pellets in accordance with an embodiment of the invention. Preferably, to facilitate blending, the pellets are approximately the same size as the chunks, e.g., may have a largest dimension of about 4″, preferably 2″, and outputs preferably 1″.

Alternatively, the uniform mixture of additive ingredients may be placed into the cavities of a mold. The mold may be made from a suitable non-stick material, such as coated stainless steel or silicone. The cavities of the mold have a desired shape and size for defining the pellets. For example, to form a pellet having a length of 1″ and a diameter of 0.5″, the mold may have 1″×0.5″ openings. The uniform mixture may then be frozen in the mold in a CRYOGRAN IQF tunnel, and the frozen pellets subsequently removed from the mold.

Accordingly, a typical pellet includes at least two additive ingredients mixed together and then frozen. One of the additive ingredients may serve as a carrier and a second additive ingredient may be in granulated form. Preferably, the additive ingredients are well mixed in the pellet, e.g., the second additive ingredient may be uniformly distributed throughout the carrier.

The frozen additive ingredient(s) form the base component additive. The base component additive may include individual chunks of ingredients, as well as pellets.

Each of the base component ingredients is whole, unrefined and/or unprocessed. Each of the additive ingredients is not dried, and is whole, unrefined and/or unprocessed. The frozen plant-based breakfast bowl precursor composition does not contain added sugar, artificial ingredients, and artificial preservatives.

The base component and base component additive are combined in a package. In some embodiments, the base component may be frozen only after being combined with the additive in the package.

The frozen breakfast bowl precursor composition may be packaged as a single portion in a sealed, single-service container. A suitable container is a 16 ounce cardboard cup with a removable lid, although any other container size may be used, such as 4 ounce, 8 ounce, 12 ounce, 20 ounce, 24 ounce, etc. In some embodiments, multiple portions of the breakfast bowl precursor composition may be packaged in a sealed container. For example, a suitable multiple portion container is a 32 ounce cardboard cup with a removable lid, although any other container size may be used, such as 8 ounce, 16 ounce, 24 ounce, 40 ounce, 48 ounce, etc.

In an exemplary embodiment, a 16 ounce container may include a frozen mixture of 2 ounces of base component and 3 to 7 ounces of base component additive, with the precursor composition including at least 20 vol % base component.

### Method of Preparation of Plant-Based Breakfast Bowl Precursor Composition for Consumption

The breakfast bowl compositions described above may be prepared for consumption by a consumer as follows. Grains are porous, and thus absorb and retain liquid. Generally, grains and chia absorb greater amounts of liquid than other seeds and nuts. Accordingly, dry base components such as grains, seeds, and nuts, e.g., oats, chia, and nuts, absorb sufficient liquid via soaking to create the desired and edible texture. This process may be accelerated with the use of heating.

### Cold

1. Open a 16 ounce container including a frozen plant-based breakfast bowl precursor composition, i.e., a mixture of 3.5 ounces of base component and 2 ounces of base component additive.
2. Fill container with milk of choice, either to the top for a thinner consistency or, e.g., ¾ of the container for a thicker consistency. Stir.
3. Put lid back on container and soak overnight, e.g., 4-12 hours.
4. Stir before eating and enjoy cold. Lid may be replaced to take to go.

### Hot

1. Open a 16 ounce container including a frozen plant-based breakfast bowl precursor composition, i.e., a mixture of 3.5 ounces of base component and 2 ounces of base component additive.
2. Fill container with milk of choice, either to the top for a thinner consistency or, e.g., ¼ of the container for a thicker consistency. Stir. Replace lid onto the container
3. Heat in a saucepan over stovetop or empty contents in a microwave-safe bowl and heat for 3-6 minutes—stirring halfway through heating time until desired consistency is reached.
4. Stir thoroughly, return to container and enjoy hot. Lid may be replaced to take to go.

### EXAMPLES

### Example 1

### Cinnamon Protein+Banana Overnight Oats

OATS—ROLLED 2.00 oz

BANANA 3.36 oz

MAPLE SYRUP 0.63 oz

PEA PROTEIN 0.37 oz

CINNAMON 0.07 oz

REISHI MUSHROOMS 0.03 oz

CHICKPEAS 2.00 oz

CACAO NIBS 0.64 oz

### Example 2

### Black Majik Chia Parfait

CHIA BLACK 1.80 oz

BANANA 4.50 oz

BLACKBERRIES 2.00 oz

HEMP HEARTS 0.30 oz

LEMON JUICE 0.08 oz

COCONUT MILK 0.14 oz

BLUE MAJIK 0.03 oz

SPIRULINA 0.05 oz

The following table includes various parameters associated with various embodiments of compositie constituents, and ingredients of the invention. Minimum, nominal, and maximum values of these parameters are provided to give guidance to certain embodiments. Lower/smaller and greater/larger values are within the scope of the invention.

| Parameter | Min. value | Nominal value | Max. value | (units) |
|---|---|---|---|---|
| Largest pellet | 0.25″ | 0.7 | 1″ | inches |
| dimension | | | | |
| Shortest pellet | 0.25″ | 0.7 | 1″ | inches |
| dimension | | | | |

While several aspects of the present invention have been described and depicted herein, alternative aspects may be effected by those skilled in the art to accomplish the same objectives. Accordingly, it is intended that the appended claims cover all such alternative aspects as fall within the true spirit and scope of the invention.

What is claimed is:

1. A frozen plant-based breakfast bowl precursor composition comprising:
a frozen mixture of
a base component selected from the group consisting of a grain, a seed, a nut, and combinations thereof, and
a base component additive comprising at least one fruit,
wherein (i) the base component is at least one of whole, unrefined, and unprocessed, (ii) each base component additive ingredient is not dried and is at least one of whole, unrefined, and unprocessed, (iii) the composition is further characterized by an absence of refined sugar, artificial ingredients, and artificial preservatives, (iv) the frozen mixture comprises at least 20% by volume of the base component.

2. The frozen plant-based breakfast bowl precursor composition of claim 1, wherein base component comprises a grain selected from the group consisting of oats, wheat, quinoa, buckwheat, farro, spelt, millet, rice, and teff.

3. The frozen plant-based breakfast bowl precursor composition of claim 1, wherein the base component comprises a seed selected from the group consisting of chia, sesame, pumpkin, hemp, and cacao.

4. The frozen plant-based breakfast bowl precursor composition of claim 1, wherein the base component comprises a nut selected from the group consisting of almonds, walnuts, coconut, hazelnuts, pine nuts, cashews, pistachios, and pecans.

5. The frozen plant-based breakfast bowl precursor composition of claim 1, wherein the base component additive comprises a fruit selected from the group consisting of strawberry, banana, avocado, blueberry, raspberry, cherry, apple, lychee, mango, pineapple, dragon fruit, mulberry, acai, and fig.

6. The frozen plant-based breakfast bowl precursor composition of claim 1, wherein the base component additive further comprises at least one additional additive ingredient selected from the group consisting of fruits, vegetables, roots, spices, herbs, seeds, nuts, and legumes.

7. The frozen plant-based breakfast bowl precursor composition of claim 6, wherein at least two base component additive ingredients are in pellet form, each pellet comprising at least two additive ingredients mixed together with at least one of the additive ingredients being in granulated form.

8. The frozen plant-based breakfast bowl precursor composition of claim 7, wherein at least one of the additive ingredients is a carrier with the granulated additive ingredient mixed therein.

9. The frozen plant-based breakfast bowl precursor composition of claim 6, wherein the base component additive comprises a vegetable selected from the group consisting of carrot, sweet potato, corn, pumpkin, avocado, zucchini, mushroom, and beet.

10. The frozen plant-based breakfast bowl precursor composition of claim 6, wherein the base component additive comprises a root selected from the group consisting of taro root, turmeric and ginger.

11. The frozen plant-based breakfast bowl precursor composition of claim 6, wherein the base component additive comprises a spice selected from the group consisting of cinnamon, nutmeg, allspice, vanilla, clove and cardamom.

12. The frozen plant-based breakfast bowl precursor composition of claim 6, wherein the base component additive comprises an herb selected from the group consisting of lemon balm, spearmint, peppermint, basil, parsley, cilantro, lavender, rosemary, sweet leaf, and chili pepper.

13. The frozen plant-based breakfast bowl precursor composition of claim 6, wherein the base component additive comprises a seed selected from the group consisting of cacao, sesame, pumpkin, hemp, and chia.

14. The frozen plant-based breakfast bowl precursor composition of claim 6, wherein the base component additive comprises a nut selected from the group consisting of almond, hazelnut, pecan, walnut, brazil nut, cashew, pine nut, and coconut.

15. The frozen plant-based breakfast bowl precursor composition of claim 6, wherein the base component additive comprises a legume selected from the group consisting of peanuts, chickpeas, lentils, peas, and beans.

16. The frozen plant-based breakfast bowl precursor composition of claim 1, wherein the composition is disposed in a sealed container.

17. The frozen plant-based breakfast bowl precursor composition of claim 16, wherein the composition comprises a single portion disposed in the sealed container, and the sealed container has a size selected from a range of 4 to 24 ounces.

18. The frozen plant-based breakfast bowl precursor composition of claim 16, wherein the composition comprises multiple portions disposed in the sealed container, and the sealed container has a size selected from a range of 8 to 48 ounces.

19. The frozen plant-based breakfast bowl composition of claim 15, wherein the composition is prepared for consumption by addition of a liquid to the container.

20. A method for making a plant-based breakfast bowl for consumption, the method comprising the steps of:
providing a frozen mixture of:
a base component selected from the group consisting of a grain, a seed, a nut, and combinations thereof, and
a base component additive comprising a fruit,
wherein (i) the base component is at least one of whole, unrefined, and unprocessed, (ii) each additive ingredient is not dried and is at least one of whole, unrefined, and unprocessed (iii) the composition is further characterized by an absence of refined sugar, artificial ingredients, and artificial preservatives, and (iv) the frozen mixture comprises at least 20% by volume of the base component. adding a liquid to the frozen mixture; and
stirring the mixture and the liquid; and
at least one of heating or cooling the mixture and the liquid to form the breakfast bowl.

21. The method of claim 20, wherein heating the mixture and liquid comprises heating with a microwave.

22. The method of claim 20, wherein cooling the mixture and liquid comprises cooling in a refrigerator for 4-12 hours.

23. The method of claim 20, wherein the base component additive further comprises at least one additional additive ingredient selected from the group consisting of fruits, vegetables, roots, spices, herbs, seeds, nuts, and legumes.

24. The method of claim 20, wherein the frozen mixture is provided in a sealed container.

25. The method of claim 24, wherein the sealed container contains a single portion of the frozen mixture, and the sealed container has a size selected from a range of 4 to 24 ounces.

26. The method of claim 24, wherein the sealed container contains multiple portions of the frozen mixture, and the sealed container has a size selected from a range of 8 to 48 ounces.

27. A method of preparing a frozen plant-based breakfast bowl precursor composition, the method comprising the steps of:
preparing a base component by at least one of hulling and shelling a grain, seed, or nut;
preparing a base component additive comprising at least one additive ingredient comprising a fruit by (i) chopping the fruit and (ii) freezing the fruit; and
forming a frozen mixture of the base component and the base component additive by mixing together the base component and the base component additive,
wherein (i) the base component is at least one of whole, unrefined, and unprocessed, (ii) each additive ingredient is not dried and is at least one of whole, unrefined, and unprocessed, (iii) the composition is further characterized by an absence of refined sugar, artificial ingredients, and artificial preservatives, and (iv) the frozen mixture comprises at least 20% by volume of the base component.

28. The method of claim 27, wherein the base component additive further comprises at least one additional additive ingredient selected from the group consisting of fruits, vegetables, roots, spices, herbs, seeds, nuts, and legumes.

29. The method of claim 28, wherein the base component additive comprises a pellet comprising at least two additive ingredients mixed together with at least one of the additive ingredients being in granulated form.

30. The method of claim 29, wherein at least one of the additive ingredients is a carrier with the granulated additive ingredient mixed therein.

31. A food article comprising:
a sealed container; and
disposed within the container, a frozen mixture of
a base component selected from the group consisting of a grain, a seed, a nut, and combinations thereof, and
a base component additive comprising a fruit,
wherein (i) the base component is at least one of whole, unrefined, and unprocessed, (ii) each additive ingredient is not dried and is at least one of whole, unrefined, and unprocessed (iii) the composition is further characterized by an absence of refined sugar, artificial ingredients, and artificial preservatives, and (iv) the frozen mixture comprises at least 20% by volume of the base component.

32. The food article of claim 31, wherein the sealed container contains a single portion of the frozen mixture.

33. The food article of claim 31, wherein the sealed container contains multiple portions of the frozen mixture.

34. The food article of claim 31, wherein the base component additive further comprises at least one additional additive ingredient selected from the group consisting of fruits, vegetables, roots, spices, herbs, seeds, nuts, and legumes.

35. The method of claim 34, wherein the base component additive comprises a pellet comprising at least two additive ingredients mixed together with at least one of the additive ingredients being in granulated form.

36. The method of claim 35, wherein at least one of the additive ingredients is a carrier with the granulated additive ingredient mixed therein.
